(19) United States
(12) Patent Application Publication
(10) Pub. No.: US 2017/0328479 A1
(43) Pub. Date: Nov. 16, 2017

(54) CARTRIDGE VALVE

(71) Applicant: Resat DEMIRCIOGLU, Istanbul (TR)

(72) Inventor: Resat DEMIRCIOGLU, Istanbul (TR)

(73) Assignees: Resat DEMIRCIOGLU, Istanbul (TR); Zekai YILDIZ, Manhattan Beach,, CA (US)

(21) Appl. No.: 15/262,243

(22) Filed: Sep. 12, 2016

(30) Foreign Application Priority Data
May 13, 2016 (TR) U 2016/06342

(51) Int. Cl. F16K 5/04; F16K 31/60; E03C 1/02

(52) U.S. Cl. CPC F16K 5/04; F16K 31/602; E03C 1/02

(57) ABSTRACT

A valve structuring designed for use in all water installations, water inlets for houses, kitchen installations and embedded shower filters as a stop valve, in the areas to perform on-off control, in faucets with the purpose of providing water savings and to use in domestic and industrial type kitchen faucets as a stop valve. The valve is designed for use as an on-off valve in air installations that operate with air.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The valve, which is the subject-matter of the invention, is on a valve design that operates by turning on-turning off system ceramic cartridge. The valve is used in all plumbing installations, water inlet and outlets, for turning on and turning off the water, in bathrooms or in connections of plumbing installations with each other and also used in varied fields instead of stop, ball and mini valves.

It is also on a valve structuring used in all air installations or in the air passages and closures that operate with air.

### 2. Description of Related Art Including Information Disclosed Under 37 CFR 1.97 and 37 CFR 1.98

Known status of the technique of the invention: The subject-matter invention is a type of valves that are currently manufactured.

Stop valves are rotary valves which have on-off mechanism with gasket and turns on and turns off via butterfly lever handle with valve gasket.

A ball valve is a valve turning on and turning off by turning the lever handle to the right and left and operating with two conical Teflon gaskets placed oppositely in their places in the sectional body and a ball placed between two gaskets and a rod stem placed in the rod gutter opening into the top of the ball and a butterfly lever placed on this rod stem.

A mini valve is included in a ball valve group and used as mini ball valve that contains two conical Teflon gaskets placed in their places in a single body and a ball placed between these Teflon gaskets and the ball is controlled with the help of nut tightened up from the back of the valve and on-off mechanism is turned on and turned off via a lever with o-ring gasket placed in the rod groove opening into the top of the ball of valve.

There are also stop systems that are operated by turning to the right and left or pushing backwards and forwards to stop the ongoing water of a hand shower. However, they do not function and break down soon.

The other valve type operating in air systems is a jack system; spring, o-ring gasket and ball are placed inside of it. There is also another type of valve system in the form of air valve which turns off as a result of backward compression of the air on the ball towards the gaskets and turns on by pushing back the ball with jack.

### BRIEF SUMMARY OF THE INVENTION

The valve, which is the subject-matter of the invention, will be used for turning on and turning off the water or air in water installations and air installations, mostly in bathrooms, toilets, embedded showers or in need transition areas. The on-off mechanism will be easier and more practical. Also, it will not appear messy from the point of visual view.

It is not multi-turn like other valves, provides convenience in turning on-off with a single-touch motion and saving on time was purposed.

Also, this valve is an innovative valve which will provide convenience in new solutions for installations. It was targeted to provide a hygienic environment for installation spaces.

### BRIEF DESCRIPTION OF THE SEVERAL VIEWS OF THE DRAWINGS

FIG. 1 is a side cross-sectional view and numbered figure of the valve according to the cartridge without a stand.

FIG. 2 is a top cross-sectional view and numbered shape of the valve according to the cartridge without stand.

FIG. 3 is a side cross-sectional view and numbered figure of sealing gasket set (13) and water inlet channel (17) for the cartridge stand of the valve according to the stand cartridge.

FIG. 4 is a top cross-sectional view and numbered figure of water inlet channel (17) for the stand cartridge of the valve according to the stand cartridge.

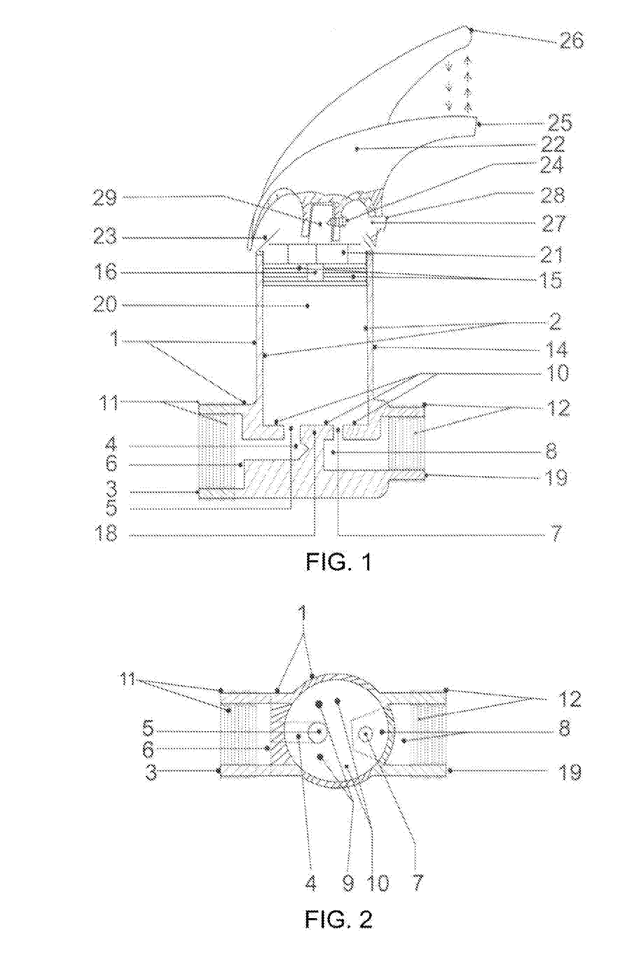

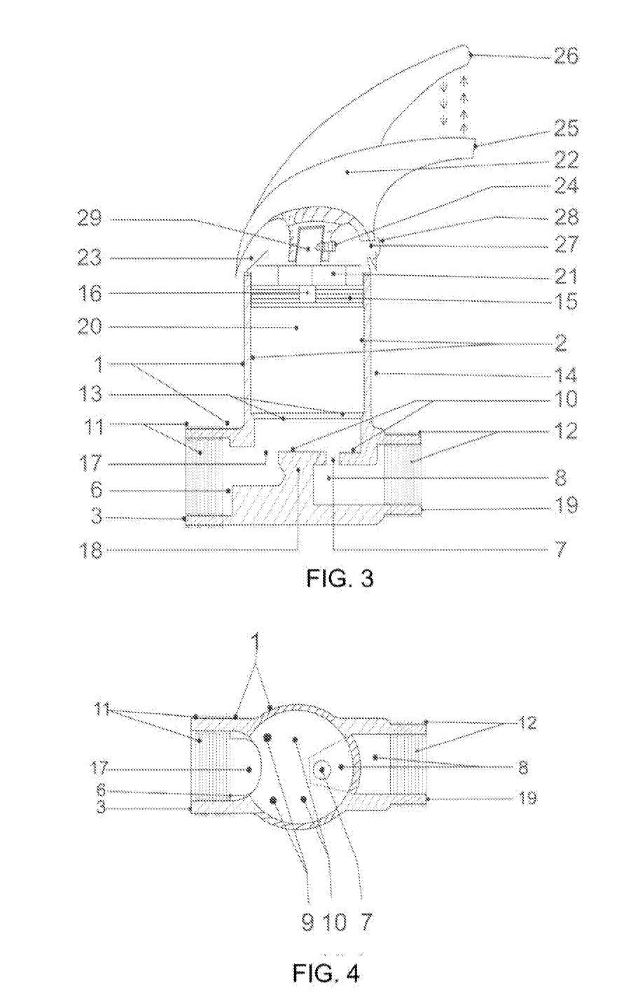

Important parts and pieces of the subject-matter invention are numbered and corresponding numbers of these are specified below.
1. Main body
2. Cartridge seat
3. Pipe for water inlet
4. Channel for water inlet
5. Hole for water inlet of the cartridge
6. Seal seat
7. Hole for water outlet
8. Pipe channel for water outlet
9. Cartridge bead seats
10. Flat surface of the cartridge
11. Internal and external threads
12. Internal and external threads
13. Sealing gasket set
14. Cartridge wall
15. Counter-nut threads of the cartridge
16. Additional bead seat
17. Channel for water inlet of the stand cartridge
18. Separator
19. Pipe for water outlet
20. Cartridge
21. Counter-nut of the cartridge
22. Joystick
23. Funnel
24. Fixing screw for the joystick
25. Closed status
26. Opened status
27. Hole cover seat
28. Hole cover
29. Cartridge arm

### DETAILED DESCRIPTION OF THE INVENTION

The subject-matter valve is a valve structuring which operates with an on-off cartridge system, unlike other valve systems, the cartridge wall (14) to fix the cartridge in its seat on main body of the valve, and cartridge seat in which cartridge functions in the cartridge wall, and under the cartridge seat, a flat surface on which cartridge is settled in and under this surface, the channels for water inlet and outlet and the system completing all these were developed. For the function of the subject-matter valve with the cartridge system, the main body of the valve (1) was designed in a form so as to operate the cartridge system. The round cartridge wall (14), which is applied to the main body, is structured for fixation of the cartridge which performs on-off mechanism of the valve. Inside this cartridge wall (14), 380 degree round cartridge seat (2) was structured to the function of the valve. Under the cartridge seat (2), flat surface of the cartridge (10) was designed for the settlement of the cartridge and for opening water inlet hole (5) and water outlet hole (7) for the cartridge and for opening the bead seats (9) to fix the cartridge. The cartridge valve system was designed for bringing water inlet channel and water outlet channels together under the flat surface of the cartridge by drilling water inlet and water outlet holes from this flat surface. To be able to provide water inlet into the valve by this developed system, the water inlet channel (4) was opened from the inside of water inlet pipe (3) and under the flat surface of the cartridge (10) for the cartridge that will operate the valve. And the water inlet hole for the cartridge (5) was drilled from the flat surface of the cartridge and by bringing water inlet channel and the water inlet hole together, water filling into the cartridge (20) is provided.

To be able to direct the filled water up to the cartridge (20), which will perform on-off of mechanism of the mentioned valve above, towards the output direction of the installation through the cartridge, water outlet hole (7) is drilled from flat surface of the cartridge (10) and reaching up to under the flat surface of the cartridge, previously opened hole is brought together with the water outlet channel (8) and so outlet of water from the valve is provided to be passed through the water outlet pipe (19).

Water channels are separated from each other with the water separator (18), which separates the water inlet hole (5) and water outlet hole (7) of the cartridge from each other under the flat surface of the cartridge (10) and so a work system of the valve for water inlet and water outlet is generated.

Cartridge bead seats (9), which are for the fixation of the cartridge seat (2), are formed on the flat surface of the cartridge (10) and the cartridge (20), which will perform on-off mechanism of the valve, is provided to be fixed.

When the stand cartridge (20) is used in the valve, which is the subject-matter of the invention, sealing gasket set (13) is applied to provide a seal in the lower part of 380 degree round cartridge seat (2) and so seal is provided with the gaskets of the cartridge that are placed on the flat surface of the cartridge (10).

To be able to fix all cartridges (20) with stand and without stand, which function the valve, counter-nut threads (15) of the cartridge are generated in the inlet part of the cartridge seat (2). The cartridge is screwed on these threads with counter-nut of the cartridge (21) and the cartridge is tightened up and seal of the valve is provided.

When the cartridge (20) type with bead seats on the inlet part is used for the valve, which is the subject matter of the invention, additional bead seat (16), which is opening into in the inlet part of the cartridge seat (2), is applied to be able to fix the cartridge on the valve.

When stand cartridge is used, water inlet channel (4) and water inlet hole (5) for the valve are removed during the manufacture and instead, 380 degree round cartridge seat (2) is drilled from the lower part of the wall during press manufacturing or in turning way, the channel is opened towards flat surface of the cartridge (10) and water separator (18) and so water inlet channel for the cartridge (17) is opened and direct filling of the water into the cartridge (20) is provided.

To ease the assembly of the valve in the direction of water inlet pipe (3), seal seat (6) is formed around the water inlet channel (4) and so technically assembly of the valve on the installation is eased without using linen, Teflon band or adhesives & sealants.

At manufacturing stage, according to the position of the cartridge to be used, additional bead seat (16), that is formed at the inlet of 380 degree round cartridge seat, changes place in the cartridge seat.

By this design, main body (1), cartridge wall (14), 380 degree round cartridge seat (2), water inlet pipe (3) and water outlet pipe (19) of the valve, which is the subject-matter of the invention, will be applied according to the dimension (size) of the intended cartridge (20), big-small stand, joystick or rotary cartridges (20) and cartridges without stand will be applied.

In various cartridges (20) applications that provide the function of the valve, a water inlet hole (5) and water outlet hole (7) and cartridge bead seats (9) can change place on the flat surface of the cartridge (10) according to the position of the cartridge to be used.

In the installation, to be able to bidirectionally install the valve, which is the subject-matter of the invention, internal and external threads (11) are opened on water inlet pipe (3) and internal and external threads (12) are opened on the water outlet pipe so connection of the valve to the installation is structured.

To make the valve functional, the cartridge (20), which is placed in the cartridge seat, is fixed on counter-nut threads (15) of the cartridge by screwing the counter-nut (21) to be able to obtain fixation in the seat. Joystick (22) is tightened up on the cartridge arm (29), which will turn on and turn off the valve, with joystick fixing nut (24) and then funnel (23) is applied. To be able to fix the joystick (22) and cartridge arm (29) with each other, the nut on joystick (22) arm is applied in its hole, hole cover (28) is applied in hole cover seat (27) and so the valve is completed.

When the completed valve is in closed status (25) joystick is in lower position. It is in upper position when the valve is in opened status (26). When cartridge arm is lifted up for water flow through the valve, water channels of the cartridge are positioned in opened status (26) by the motion gained from joystick (22), which is connected to the cartridge arm (29), so it drains the water. When it is downed, water passage channels of the cartridge are positioned in closed status (25) so the valve turns into closed status.

Working Principle of the Valve

Working principle and type of assembly of the valve, which is the subject-matter of the invention, main body (1) of the valve is designed for working system of the valve, which is subject-matter of the invention, and the cartridge that will operate the valve is designed on this main body, the cartridge is fixed in its seat in the cartridge wall (14) and in 380 degree cartridge seat (2), which is formed in this cartridge wall, and the cartridge (20) is placed in the cartridge bead seats on flat surface of the cartridge; and the water fills up to the cartridge (20) of water valve through water inlet pipe (3), water inlet channel (4) and cartridge water inlet hole (5).

When the joystick (22), which is connected to the cartridge arm (29), is lifted up by the motion gained from cartridge arm, water passage channels of the cartridge (20) are opened and water outlet of the valve is provided. The water passes through the water outlet pipe channel (8) and water outlet hole (7) that was opened under the flat surface (10) of the cartridge and exits from the valve through the water outlet pipe (19).

In stand cartridge applications: sealing gasket set (13) and water inlet channel (17) for stand cartridge are applied during the manufacturing of the valve. Stand cartridge is placed in this seat in the same way as the cartridge without stand, the cartridge is tightened up on counter-nut threads of the cartridge (15) with counter nut of the cartridge, and the seal is provided.

Bead seats (9) are located on the flat surface of the cartridge (10) in the valve, which is the subject matter of the invention. For the cartridges (20) that have bead seats on the inlet part, additional bead seat (16) is applied during the manufacturing.

Assembly of the valve: for the assembly of the cartridge on the valve, the cartridge (20) is placed in 380 degree round cartridge seat (2) on main body (1) of the valve. The cartridge, which is placed in its seat, settles in cartridge bead seats (9) water inlet hole of the cartridge (5) and water outlet hole of the cartridge (7) on flat surface of cartridge (10). The cartridge, which is placed in its seat, is fixed on counter-nut threads of cartridge (15) screwing with counter-nut of cartridge (21). Then, its funnel (23) is screwed on counter-nut of cartridge (21). Joystick (22) is applied on the cartridge arm (29) and tightened up with joystick fixing screw (24). Hole cover (28) is applied on the hole cover seat (27) and so the assembly of the valve is completed.

Working principle of the valve, which is the subject-matter of the invention; when the valve is in closed status (25), joystick of the valve is in lower position. When the cartridge arm (29), which operates the valve, is lifted up by the motion gained from joystick (22), water outlet channels of the cartridge (20) are positioned in opened status (26). The valve, which is the subject matter of the invention, starts to operate with single-touch motion and performs on-off.

Connection of the valve to the installation: to connect the subject-matter valve easily to the installation, gasket is placed in gasket seat (6) inside the water inlet pipe (3) and the valve is connected to the installation in the direction of water inlet with previously prepared internal and external threads (11) on water inlet pipe (3). To connect the valve to the installation in the direction of water outlet, the valve is connected to the installation in the direction of water outlet with previously prepared internal and external threads (12) on the water outlet pipe (19).

1. A cartridge system of a valve is designed to operate with a system in form of turn on-turn off, the valve contains a main body that is designed in accordance with that and a cartridge wall that protects a cartridge seat that will operate the valve on this main body and 380 degree round cartridge seat that provides the operation of the cartridge in this wall and a flat surface of the cartridge that is opening into water inlet and water outlet holes of the cartridge and bead seats of the cartridge and a water inlet channel of the valve that provides water inlet from the installation and a water inlet hole of the cartridge that is opening from the flat surface of the cartridge and a water outlet hole and water outlet channel from the valve to the installation and a separator that separates water inlet hole of the cartridge and the water outlet hole from each other, and bead seats of the cartridge that provides fixation of the cartridge and a sealing gasket set that provides water seal in stand cartridges and counter-nut threads of the cartridge that provides tightening of the cartridge in the cartridge seat and an additional bead seat and the water inlet channel of the stand cartridge and the gasket seat that provides easy connection of the valve to the installation.

2. A cartridge valve structuring as defined in the claim 1, having a main body that is structured for operating the valve with a cartridge system and cartridge wall that structures 380 degree round cartridge seat on this body.

3. A cartridge valve structuring as defined in the claim 1, having a 380 degree round cartridge seat that is structured in the cartridge wall to perform on-off mechanism of the valve and the bead seats under this seat and flat surface of the cartridge that has openings of water inlet and outlet holes of the cartridge.

4. A cartridge valve structuring as defined in the claim 1, having a water inlet channel of the valve in the direction of water inlet pipe of the valve and under the flat surface of the cartridge and the water inlet hole of the cartridge that is opening from the flat surface of the cartridge.

5. A cartridge valve structuring as defined in the claim 1, having a water outlet hole, which is an opening into the flat surface of the cartridge, provides outlet of the filled water up to the cartridge from the valve when water passage channels of the cartridge are opened and water outlet pipe channel that provides an output of the water from the valve.

6. A cartridge valve structuring as defined in the claim 1, having a separator that is opened on a flat surface of the cartridge and separate water inlet hole and water outlet hole of the cartridge from each other.

7. A cartridge valve structuring as defined in the claim 1, having bead seats that are for fixation of the cartridge on flat surface of the cartridge in its seat.

8. A cartridge valve structuring as defined in the claim 1, having a sealing gasket set that is structured inside the 380 degree cartridge seat and provides seal of the valve when stand cartridge is used in the valve and counter-nut threads of the cartridge on which counter nut of the cartridge is screwed and provides fixation of the cartridge.

9. A cartridge valve structuring as defined in the claim 1, having an additional bead seat that is opening in in the inlet part of the cartridge seat due to removing bead seats of the cartridge on the flat surface of the cartridge when cartridges with bead seats on opening part of the valve are used.

10. A cartridge valve structuring as defined in the claim 1, having a water inlet channel into the stand cartridge instead due to removing water inlet channel and water inlet hole when said stand cartridge is used in the valve.

11. A cartridge valve structuring as defined in the claim 1, having a sealing seat that provides easy connection of the water inlet pipe of the valve to the installation.

12. A cartridge valve structuring as defined in the claim 1, having an additional bead seat that is opened in the opening of 380 degree round cartridge seat and can be changed in the cartridge seat.

13. A cartridge valve structuring as defined in the claim 1, having a small, big, joystick, stand or rotary cartridges and cartridges without stand in all dimensions that will be used for operating the valve in 380 degree round cartridge seat structured on the valve body.

14. A cartridge valve structuring as defined in the claim 1, having a water inlet hole and water outlet hole and bead seats of the cartridge about changing the water inlet and water outlet holes that are opened on the flat surface of the cartridge in varied cartridge applications.
